(19) United States
(12) Patent Application Publication
(10) Pub. No.: US 2024/0173181 A1
(43) Pub. Date: May 30, 2024

(54) Motorized Mobility Device

(71) Applicant: Niraj Patel, Arlington, VA (US)

(72) Inventor: Niraj Patel, Arlington, VA (US)

(21) Appl. No.: 17/994,527

(22) Filed: Nov. 28, 2022

(51) Int. Cl. A61G 5/10; A61G 3/02

(52) U.S. Cl. CPC A61G 5/1059; A61G 3/0209; A61G 5/125

(57) ABSTRACT

A motorized mobility device provides a level of functionality required by users of devices that fall into the complex rehabilitation technology (CRT) category. The motorized mobility device is composed of four component parts that are easily completely detachable from one another. This allows the motorized mobility device to be disassembled so it can be easily transported, and for components of the device to be used independently from one another, in particularly to allow the user to safely and securely travel in an unmodified, widely available commercial vehicle using the LATCH restraint system.

### BACKGROUND

### Technical Field

This disclosure relates to mobility devices. In particular, but without limitation, the disclosure relates to a motorized mobility device for complex rehabilitation therapy users and patients.

Mobility devices are known in the art.

U.S. Pat. No. 8,012,107 discloses methods and apparatus for rehabilitation and training.

U.S. Pat. No. 9,636,993 discloses systems, methods and devices for the physical rehabilitation using an electrically motorized vehicle.

U.S. Pat. No. 11,075,910 discloses a secure systems architecture for integrated motorized mobile systems.

However, none of the present attempted solutions for motorized mobility devices provide a convenient and modular device that can easily be disassembled and assembled for transport in a vehicle.

Therefore, a need exists for a modular motorized mobility device for users in a complex rehabilitation therapy category that can be easily disassembled and assembled for transport in a vehicle.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclosure, a motorized mobility device is disclosed which provides a level of functionality required by users of devices that fall into the complex rehabilitation technology (CRT) category. In an aspect of the disclosure, the motorized mobility device is composed of four component parts that are easily completely detachable from one another. The disclosed motorized mobility device may be disassembled so it can be easily transported, and for components of the device to be used independently from one another, in particularly to allow the user to safely and securely travel in an unmodified, widely available commercial vehicle using the LATCH restraint system.

In an aspect of the disclosure, a method for using a motorized mobility device is disclosed.

In an aspect of the disclosure, a mobility transport system for use by complex rehabilitation therapy users.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is an example view of components of the motorized mobility device according to the disclosure.

FIG. 2 is an example view of a motor/wheel component of the motorized mobility device according to the disclosure.

FIG. 3 is an example view of a base component of the motorized mobility device according to the disclosure.

FIG. 4 is another example view of a base component of the motorized mobility device according to the disclosure.

FIG. 5 is another example view of a motor/wheel component of the motorized mobility device according to the disclosure.

### DETAILED DESCRIPTION

This disclosure relates to mobility devices. In particular, but without limitation, the disclosure relates to a motorized mobility device for complex rehabilitation therapy.

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

Various aspects of the disclosure will be described in detail with reference to the drawings, wherein like reference numerals represent like parts and assemblies throughout the several views. Reference to various aspects does not limit the scope of the disclosure, which is limited only by the scope of the claims attached hereto. Additionally, any examples set forth in this specification are not intended to be limiting and merely set forth some of the many possible aspects for the claimed disclosure.

In describing aspects of the disclosure, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The disclosed motorized mobility device is an innovative, built-from-the-ground up motorized mobility device that delivers the level of functionality required by users of devices that fall into the complex rehabilitation technology (CRT) category. It eliminates the vast majority of the day-to-day difficulties caused to these users by machines currently available in-market through the motorized mobility device, which splits the device up into four distinct “pieces”.

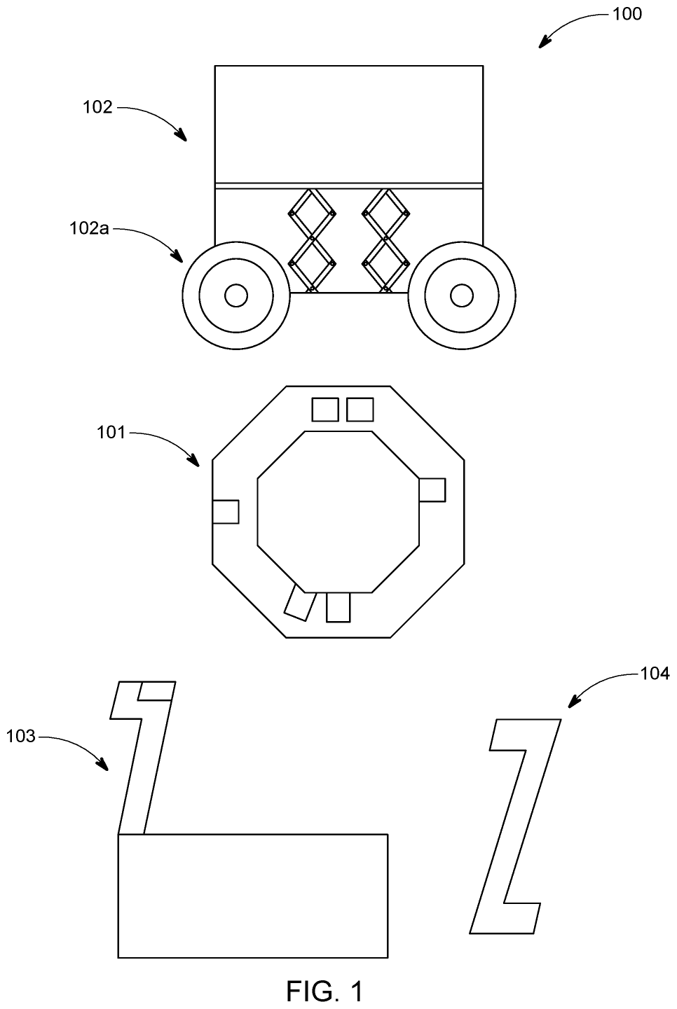

FIG. 1 is an example view of components of the motorized mobility device 100 according to the disclosure. The foundational piece is the base 101, to which all the other components of the motorized mobility device 100 connect. The base 101 is configured for use in the Complex Rehabilitation Technology (CRT) device category. The base 101 may be installed in any standard vehicle using the lower anchors of a car. This allows users of this device to safely ride in any standard sedan, SUV, or light truck with lower anchors without needing any aftermarket modifications such as ramps or securement infrastructure. The disclosed motorized mobility CRT device 100 may be advantageous in that that it can be disassembled into components where some of those components can then be installed in a standard, unmodified vehicle such that the user of the motorized mobility device 100 can then safely ride in that vehicle. As a result, the motorized mobility device 100 will expand the options that users of CRT devices have when it comes to accessing transportation via modes like taxis, ride-hailing services, or personal automobiles.

The motorized mobility device 100 is composed of four key component parts that are easily completely detachable from one another. This allows the motorized mobility device to be disassembled so it can be easily transported, and for components of the device to be used independently from one another, in particularly to allow the user to safely and securely travel in an unmodified, widely available commercial vehicle using the LATCH restraint system that has been required in most vehicles by NHTSA since Sep. 1, 2002. These component parts are:

Base 101, which is piece of hardware that is secured to the “vehicle” but can be separated from it and installed into any standard sedan and SUV using the car's lower anchors. This design of a base that works with the motorized part of the mobility device but can be separated and attached into a car's LATCH system as an advantageous aspect of the disclosure.

Vehicle 102, is a wheeled transport vehicle which has a battery-operated motor that delivers power to wheels 102a and is maneuvered via a control interface and/or a smartphone app. The wheels 102a are large and durable and can transit the vast majority of terrains.

Seat 103 is the seat of the chair in which the user sits and can come in a variety of custom configurations to account for different physical conditions of the user. The seat 103 can only be attached to the base 101. One of skill in the art may design and custom build seats for users based on the specifications they and their medical teams provide, but with the foundation of the seat 103 leveraging the present disclosure so it will always attach to a base 101 which will attach to the LATCH system in the vehicle.

Extensions 104 are extensions which will be able to be connected to the base 101 and may allow for accessory holders, foot-rests or arm rests to be added, should the user have need for those.

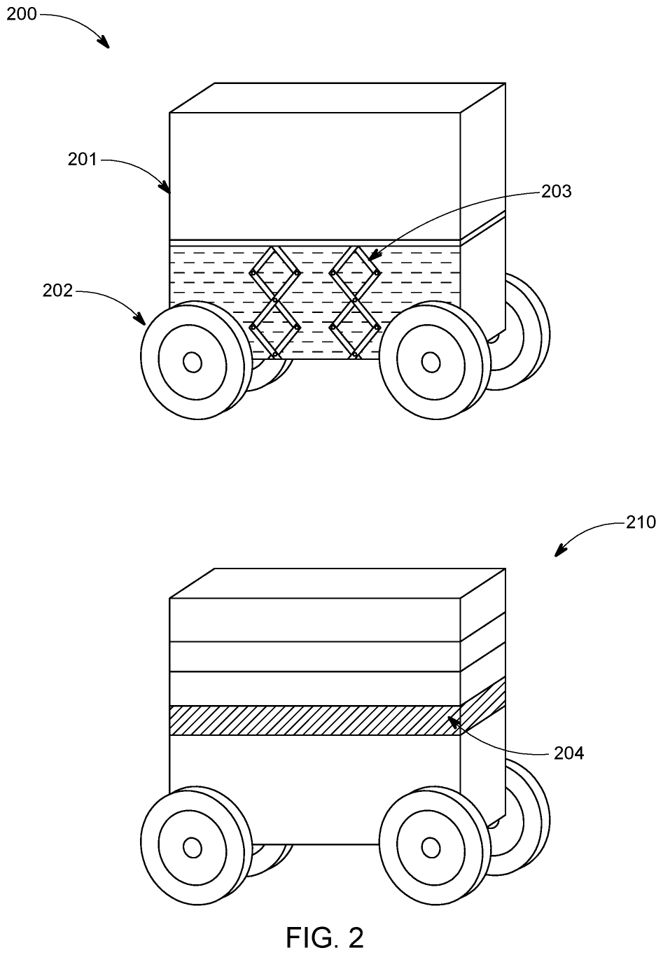

FIG. 2 is an example view 200 of the vehicle 201 according to the disclosure. In an aspect of the disclosure, the vehicle 201 is mounted on wheels 202, to form a wheeled transport vehicle. Inside the vehicle 201, where a motor (not shown) and wheels 202 are connected, a motorized lift 203 may be used to adjust the height of the motorized mobility device 100. This may allow the user to sit at different heights for different platforms, such as tables. The motorized lift 203 may allow the user to position themselves and the seat 103 laterally at the same height as another base into which they will transfer, for example, in a car.

When the motorized lift 203 is raised to a higher position within the vehicle 201 (as shown in 210), an open storage space 204 may be made available for a user's personal items.

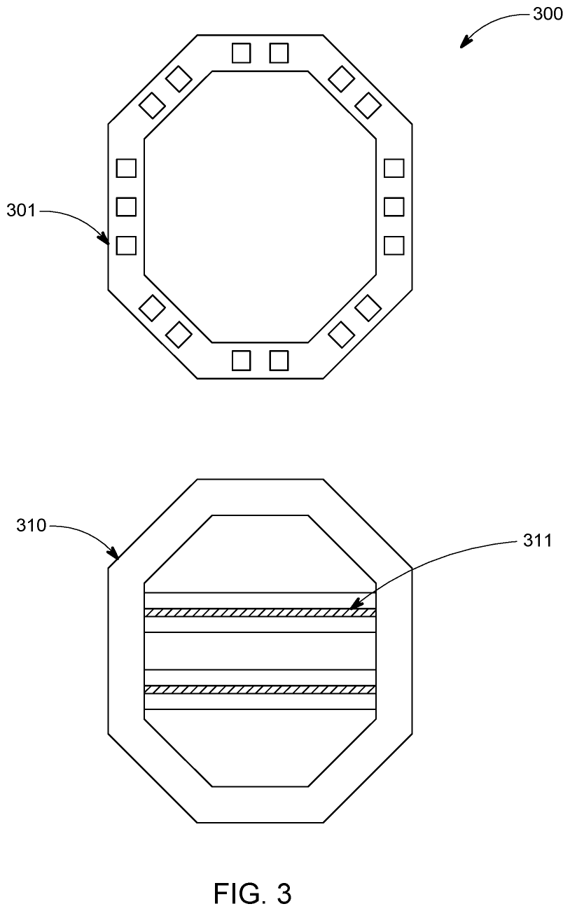

FIG. 3 is an example view of a base 300 for the motorized mobility device 100, according to the disclosure. The base 300 has inserts or ports 301 into which footwells and armrests, accessory holders and vehicle control parts may be connected. These items connected by inserts or ports 301 may be moved from side to side, such as, for example, when a user needs vehicle control on the left side instead of the right side.

Base 310 has a seat attachment mechanism 311 that the seat 103 slides in and connects to. The seat 103 can be slid off the base 310 onto a different base parallel to the motorized mobility device 100. For examples, a base 310 may be inserted into a motor vehicle, such as a car or other motor vehicle transport, using a LATCH system. The user could slide their seat 103 from this base 310 into a base in the motor vehicle and then secured into the base of the motor vehicle. The mechanism 311 could be a rail system, bolt action or other connecting mechanism known to one of skill of the art.

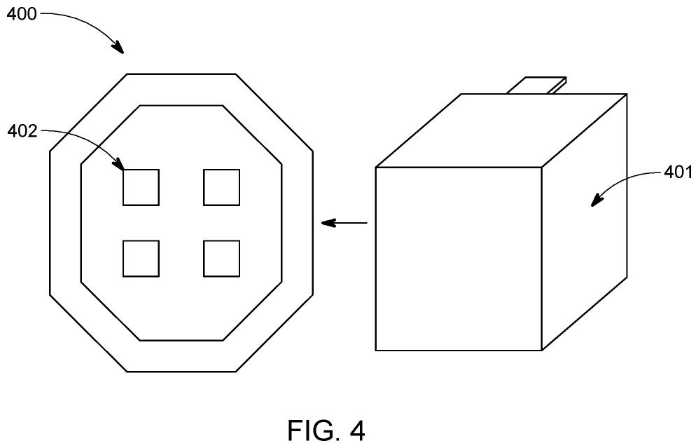

FIG. 4 is another example view of a base 400 according to the disclosure. The base 400 may be arranged so that a seat 401 may sit upon and be bolted into the base 400, via inserts/ports 402. The base 400 and the inserts/ports 402 are configured and designed appropriately so that the seat 401 is easily moved on and off the base 400.

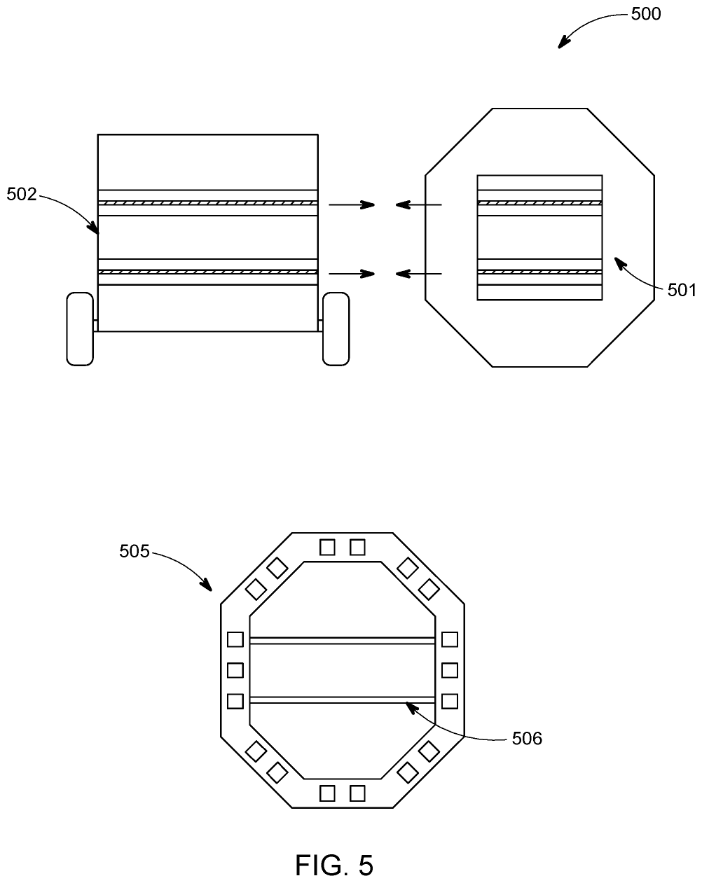

FIG. 5 is another example view of a motorized mobility device 500 with a base 501 and vehicle 502 according to the disclosure. The base 501 may secure onto the vehicle 502 with a vehicle/base attachment mechanism 503. The vehicle/base attachment mechanism 503 may be a rail system to slide the base 501 onto the vehicle 502, bolt on or other attachment mechanisms known to one of skill in the art to create smooth and easy attachment and detachment.

In an aspect of the disclosure, the base 505 seen from a top perspective, may include a seat attachment mechanism 506 for a seat (not shown) to secure into the base 505. The seat attachment mechanism 506 may be a rail system to slide the seat onto the base 505, bolt on or other attachment mechanisms known to one of skill in the art to create smooth and easy attachment and detachment.

As described with reference to FIGS. 1-5, the disclosed motorized mobility device 100 separates into these component parts (base 101, vehicle 102, seat 103 and extensions 104) and that is LATCH compatible. The base 101 serves as the bridge between letting the seat 103 couple on top of the vehicle 102 but that can also be separated to make the seat 103 something that can be installed in any car. Vehicle 102 may be a light EV powered by swappable batteries. It may come with a battery charger that can be plugged into any power outlet, and the user can have extra batteries on hand just to be sure that they never run out of power.

These battery chargers will be relatively inexpensive and use as many standard protocols (e.g., cables, etc.) as possible. Airports and other public forums should be able to have just a charger and a spare battery or two on hand for persons with disabilities should the need arise. Charging should be fast and range should be appropriate. The battery pack may be secured with anti-theft technology such that only the user of the seat and/or their delegates can allow the pack to be removed.

The configuration of the seat 103 should be adjustable such that the position the user is in can be changed and adjusted to optimize posture and ensure that no issues are caused from being in a single position for too long. Seating options will abound. Seats 103 may be composed of components that can be adjusted and swapped in and out based on user need. The user may want more of a large, soft, square platform for some cases and want a more snugly fitting ergonomic design for other use cases.

Seating options will need to be able to be made out of materials that are breathable, do or do not allow airflow, and provide skin protection options.

Each key part of the motorized mobility device 100 should be as light as possible, with each individual part absolutely able to be picked up by one able bodied person. A common challenge motorized wheelchair users face is their chairs being damaged when handled by airline baggage handling staff. The overall lighter weight of the motorized mobility device 100, modularity elements that make disassembly and/or folding possible, and other intuitive design choices should make it such that any layperson approaching handling the device with a reasonable degree of care should be able to avoid damaging it.

The seat 103 snaps into a base 101 that then secures to the vehicle. The mechanism should be similar to the way a car seat snaps into a base that is secured into the seat of a car, using the LATCH standard. The base 101 will be able to be removed from the motorized mobility device 100 and snapped into the lower anchors of any standard car or SUV, just like a car seat can be. Once snapped in, the base 101 may offer a “green light” indicator to let you know that it is properly secured into a vehicle. The result of this will be that motorized mobility device 100 users will not require specialized vehicles outfitted with ramps to be able to travel by car. The seat 103 and base 101 will be able to be lifted out and secured into any vehicle, any leg attachments will be able to be folded such that they fit in the legroom area of the vehicle or be removed if the user's physical condition allows this. The motorized mobility device 100 will eliminate the need for users to wait endless hours for a wheelchair accessible taxi or van service or ride-share—they'll simply be able to call a standard ride-share or taxi or ride with a friend.

Most likely, a user of the disclosed motorized mobility device 100 traveling in a ride-share (for example) would have one extra base with them (fitting easily in a motorized mobility device 100 storage area), have the driver or a companion install that base 101 into the vehicle, unlock the seat from the base 101 of their motorized mobility device 100, and transfer to the installed base 101 in the vehicle.

The way that seat 103 and base 101 attach/detach system will work, and the general process of transferring, will be designed with extreme care to avoid the possibility of injury. The transfer mechanism to a car works as follows:

User is sitting in their seat 103 atop the base 101 affixed to the vehicle.

The user positions themselves parallel to the seat of the car with the car door open, facing forward.

A base 101 has been installed in the car attached to the car's fastener mechanism, such as a LATCH system.

The user adjusts their height to be slightly higher than the base 101 in the car.

The user pushes a button which moves their seat 103 and base 101 laterally to the right or left (into the car) until they are atop the base in the car.

The user pushes a button which lowers their seat 103 onto the base 101 in the car.

The base 101 on the motorized mobility device 100 is designed such that it is lowered into the base 101 in the car. When it is lowered fully, the seat is latched into the in-car base 101.

The user pushes a button and the base 101 attached to the motorized mobility device 100 is retracted back to the motorized mobility device 100.

When this process is completed, the user is secured into the in-car base 101.

To reverse this process and return the user to the motorized mobility device 100, they simply position the motorized mobility device 100 next to the car and complete the process backwards, with the base 101 attached to the motorized mobility device 100, sliding into the in-car base 101, reconnecting itself to the seat 103, lifting the seat 103 back up, and then sliding back atop the motorized mobility device 100.

The height of the seat 103 will be adjustable, as the vehicle 102 will have the ability to raise or lower the platform that the base 101 attaches to. Ideally this adjustment will be electric and in the control of the user. An optional component will offer a securement device for the individual in the seat (e.g., a seat belt or lap belt).

Extensions 104 will be highly modular and can be customized to add or remove seat components based on the needs of the person using the seat. Some users will have full use of their arms and hands, others will not. Positioning of legs will vary by user. Some users will be able to get in and out of the seat and walk short distances. Modern day strollers have a wide array of attachments that can easily be added or taken away depending on the use case—the motorized mobility device 100 should follow a similar construct.

Extensions 104 may all attach to the base. The base will have “ports” distributed around its outer rim which extensions 104 can be connected into. Extensions 104 may include foot wells, arm pads, a table for eating or writing, and much more. The port is standardized and all extensions will connect into the base with the same type of connector. This allows all extensions to be connected on either side or the front or back of the device (assuming the rest of the extension has room). When an extension 104 is connected into the base 101, it may click into place and be secured until a button is pressed that allows it to be released.

The seat 103 will be operated with an intuitive control set that can be implemented in a way that aligns to the physical abilities of the user (e.g., what parts of their body they have use of). A smartphone app will also allow the user to control the seat, to the extent they are separated from the motorized mobility device 100 and want to maneuver it back to them, such as when they are getting out of bed in the morning or if they need to put their seat 103 in a different location temporarily.

The seat 103, attached to the motorized mobility device 100, can be driven forward and in reverse at various speeds, with the ability to “turn on a dime”. Some seat options that exist today can be enhanced with “power assist” devices—the motorized mobility device 100 may come standard with an amount of power that can manage steep hills and thick carpet.

The vehicle 102 may have a light on the front powered by the battery that allows the user to see ahead of them in dark or low-light conditions.

The motorized mobility device 100 may avoid highly specialized, fragile components. A common experience for motorized wheelchair users today is to have something in their seat break and to find themselves waiting months for a specialized replacement part to be provided by the manufacturer. During this time, their mobility can be completely limited, with tremendous consequences for this person's quality of life. It will not require specialized tools that are not widely available to service, maintain, and repair.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A motorized mobility device for complex rehabilitation therapy users, comprising:
a base configured for accepting one or more extensions related to the motorized mobility devices;
a seat configured to removably connect to the base using a seat attachment mechanism; and
a wheeled transport vehicle configured to removably accept the base upon a surface of the wheeled transport vehicle using a vehicle/base attachment mechanism.

2. The motorized mobility device of claim 1, where the base is configured to connect with a latch system located within a vehicle.

3. The motorized mobility device of claim 1, further comprising a motorized lift mechanism in communication with the wheeled transport vehicle and the base, where extension of the motorized lift mechanism creates a storage space between a lower surface of the base and an upper surface of a bottom of the wheeled transport vehicle.

4. The motorized mobility device of claim 1, where the one or more extensions comprise a foot-rest, an arm rest, a vehicle control part or an accessory holder.

5. The motorized mobility device of claim 1, where the vehicle/base attachment mechanism comprises a rail system to removably attach the base to the wheeled transport mechanism.

6. The motorized mobility device of claim 1, where the seat attachment mechanism comprises a rail system to removably attach the base to the seat.

7. The motorized mobility device of claim 1, where the wheeled transport vehicle comprises an electrically driven motor.

8. The motorized mobility device of claim 7, where the wheeled transport vehicle comprises rechargeable batteries or swappable batteries.

9. The motorized mobility device of claim 1, where the base comprises one or more ports configured to removably accept the one or more extensions.

10. The motorized mobility device of claim 1, where a light is positioned on a front surface of the wheeled transport vehicle.

11. A method for using a motorized mobility device for a complex rehabilitation therapy patient, the method comprising:
providing a seat on the motorized mobility device and connected to a base, the base attached to a motorized transport vehicle;
positioning a user of the motorized mobility device parallel to a seat of a vehicle to be entered, the user facing forward with the vehicle door open;
providing a base in the vehicle to be entered, the base installed to a fastener system of the vehicle to be entered;
adjusting a height of the base higher than a height of the base in the vehicle to be entered;
moving the seat and the base laterally to a direction into the vehicle to be entered until the user is atop the base of the vehicle to be entered;
lowering the base onto the base of the vehicle to be entered until the seat is secured into the fastener system of the vehicle to be entered; and
retracting the base back to the motorized mobility device.

12. The method of claim 11, further comprising providing a control device for interacting with the motorized mobility device to position the user within the vehicle to be entered.

13. The method of claim 11, where the fastener system comprises a latch system.

14. The method of claim 11, where adjusting a height of the base comprises extending or retracting a motorized lift mechanism connected to the motorized mobility device and the base.

15. A mobility transport system for use by complex rehabilitation therapy users, the mobility transport system comprising:
a mobile battery-driven vehicle platform;
a transport base removably attached to and positioned above the mobile battery-driven vehicle platform, where the transport base is configured with one or more ports to removably accept accessories for the mobility transport system; and
an adjustable seat removably attached to and positioned above the transport base.

16. The mobility transport system of claim 15, where the accessories are removably attached to the one or more ports on the transport base.

17. The mobility transport system of claim 15, further comprising a motorized lifting mechanism attached to the mobile battery-driven vehicle platform and to the transport base, where the motorized lifting mechanism is operable to raise or lower the transport base relative to the mobile battery-driven vehicle platform, where a storage space is created between the transport base and an interior surface of the mobile battery-driven vehicle platform.

18. The mobility transport system of claim 15, where the transport base is configured to be moved from the mobile battery-driven vehicle platform to a different vehicle for transport.

19. The mobility transport system of claim 15, where the transport base comprises a base attachment mechanism configured to attach to a latch system in a vehicle for transport.

20. The mobility transport system of claim 15, where the accessories comprise an arm-rest, a foot-rest, a tray table, a vehicle control device or a mobile device holder.
